(19) United States
(12) Patent Application Publication
(10) Pub. No.: US 2026/0154657 A1
(43) Pub. Date: Jun. 4, 2026

(54) SYSTEMS AND METHODS FOR FACILITATING COLLABORATIVE PLANNING AND EXECUTION

(71) Applicant: The QED Group, Arlington, VA (US)

(72) Inventor: Neelima Grover, Arlington, VA (US)

(73) Assignee: The QED Group, Arlington, VA (US)

(21) Appl. No.: 18/968,310

(22) Filed: Dec. 4, 2024

(51) Int. Cl. G06Q 10/101; G06Q 10/0631

(52) U.S. Cl. CPC G06Q 10/101; G06Q 10/063114

(57) ABSTRACT

A system including a memory and a processor is disclosed. The memory may store a plurality of predefined virtual cards. The processor may obtain real-time information associated with latest news, and update content associated with one or more virtual cards based on the real-time information. The processor may further render a set of virtual cards at a first location of a user device screen. The set of virtual cards may include the updated virtual cards. The processor may further determine that a consensus has been reached amongst a plurality of users engaged in communication session to select a virtual card from the set of virtual cards based on inputs obtained from a sensor unit. The processor may additionally cause the virtual card to automatically move from the first location to a second location of the user device screen, responsive to determining that the consensus has been reached.

### TECHNICAL FIELD

The present disclosure relates to a gamified system and method for facilitating collaborative planning and execution amongst a diverse set of users.

### BACKGROUND

Teamwork and collaborative planning are essential for successful execution of any project, especially a project involving a large team with diverse set of team members/users. For example, collaborative planning is immensely important when a project involves team members of different nationalities, cultures, backgrounds and/or languages. Such projects are regularly executed in large multi-national corporations, or across multiple universities, governments, militaries, non-government organizations (NGOs), and/or the like.

There exist firms that provide training or courses on collaborative planning, however, in many cases, such firms do not employ modern tools that can effectively facilitate collaborative planning amongst a diverse set of users.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a first example view of a user device screen in accordance with the present disclosure.

FIG. 3 depicts a second example view of a user device screen in accordance with the present disclosure.

FIG. 4 depicts a third example view of a user device screen in accordance with the present disclosure.

FIG. 5 depicts a flow diagram of an example method for facilitating collaborative planning in accordance with the present disclosure.

### DETAILED DESCRIPTION

### Overview

The present disclosure describes a system and method for facilitating collaborative planning and execution amongst a diverse set of users. The system is a digital tool that enables a plurality of users to collaborate on real-life or imagined scenarios and creates a visual output that provides a roadmap for solving one or more particularly defined problems or achieving one or more particularly defined outcomes.

The system may store a plurality of predefined virtual cards that may display text/content associated with steps or actions that the users may perform to solve a problem or achieve an outcome. The predefined virtual cards may be categorized into different categories such as “outcomes”, “inputs”, “processing”, “skills”, “learning events”, “stakeholders”, and/or the like.

When the users desire to engage in a collaborative planning exercise, the system may render a set of virtual cards, from the plurality of predefined virtual cards, on a first location of a user interface associated with a user device of the users. Responsive to the system rendering the set of virtual cards, the users may engage in a conversation to “select” at least one virtual card that may be indicative of the steps that the user group desires to undertake or an outcome that the user group desires to achieve.

In some aspects, when the users engage in the conversation described above, the system may determine that a consensus has been reached to select a virtual card, from the set of virtual cards rendered on the first location. The system may determine that a consensus has been reached to select the virtual card based on inputs obtained from one or more cameras and/or microphones disposed in proximity to the users. Responsive to determining that a consensus has been reached, the system may automatically move the virtual card from the first location to a second location of the user interface.

The system may continue to monitor the user conversation, and may move additional virtual cards from the first location to the second location when the consensus is reached on the additional virtual cards in the same manner as described above. The system may further capture a snapshot of the second location when the user conversation may be over, and may transmit the snapshot to a printer for obtaining one or more hardcopies of the second location snapshot. The users may keep the hardcopies of the second location snapshot. The second location snapshot, including the “selected” virtual cards, may act as a roadmap for the users to collectively achieve the outcomes decided by the user group.

The system may incorporate additional features to enhance the user experience. For example, the system may update content of one or more virtual cards before rendering them on the user interface first location based on latest news/current affair and/or user profiles. The system may also select the optimal set of virtual cards to be rendered on the user interface first location based on the user profiles. The system may implement one or more encryption methods (e.g., Blowfish, Twofish, RSA, etc.), data anonymization techniques, and comply with relevant local and/or global standards for secure data handling, to ensure that the information associated with the user profiles and the user interaction with the system is secured.

The system may additionally transmit a questionnaire to the users, and may update the virtual card content and/or select the optimal set of virtual cards based on the responses received from the users on the questionnaire. The system may implement one or more different ways of incorporating user feedback to improve the system performance over time (e.g., update the virtual card content, the system's usability, user interface, etc.). For instance, in one exemplary aspect, the system may seek explicit feedback from the users by transmitting a user feedback form/survey at the end of the user interaction session with the system, and then update the virtual card content over time based on the received feedback. In another exemplary aspect, the system may track users'interaction amongst themselves and/or users'movement and/or facial expressions while engaging in the interaction session with the system (e.g., via the feed obtained from the cameras and microphones), and may update the virtual card content over time based on the monitored users'interaction/movement. For example, the system may update the virtual card content if the users seem disinterested in a particular type of virtual card, as determined via the feed obtained from the cameras and microphones.

The system may additionally assign a “score” to each user engaged in the user conversation based on the inputs obtained from one or more cameras and/or microphones disposed in proximity to the users. The score may be indicative of the communication and/or collaborative skills exhibited by the user in the conversation session. The system may further identify training needs for each user based on the user's score. In some aspects, the system may additionally refine its scoring algorithms based on the user feedback obtained over time. For example, if the user feedback indicates that the system is overly lenient in user scoring (determined based on the user feedback), the system may automatically refine its scoring algorithms to correctly score the users.

In addition to scoring the users, the system may additionally offer/provide virtual gifts, badges, rewards, etc. to the users, to make the user interaction with the system more engaging. The system may also provide/display user-specific analytics to enable the users to check their (individual or group's) performance over time. Such analytics may encourage collaboration and healthy engagement amongst the users.

In further aspects, the system may be tested (e.g., user tested) or validated before it is rolled out to the users and/or when new features of the system are being implemented. The system may be tested on a small user base (that may be located locally, or may be located in different countries), and the user feedback may be incorporated into the system features before the system is rolled out to a large group of users for interaction and collaboration.

The present disclosure discloses a system and method for facilitating collaborative planning and execution amongst a diverse set of users. The system may automatically move the virtual cards on the user interface from the first location to the second location, when the users reach to a consensus on the virtual cards. The system may also cause a printer to automatically print a copy of a roadmap for project execution that the users may have decided in the collaborative planning exercise.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

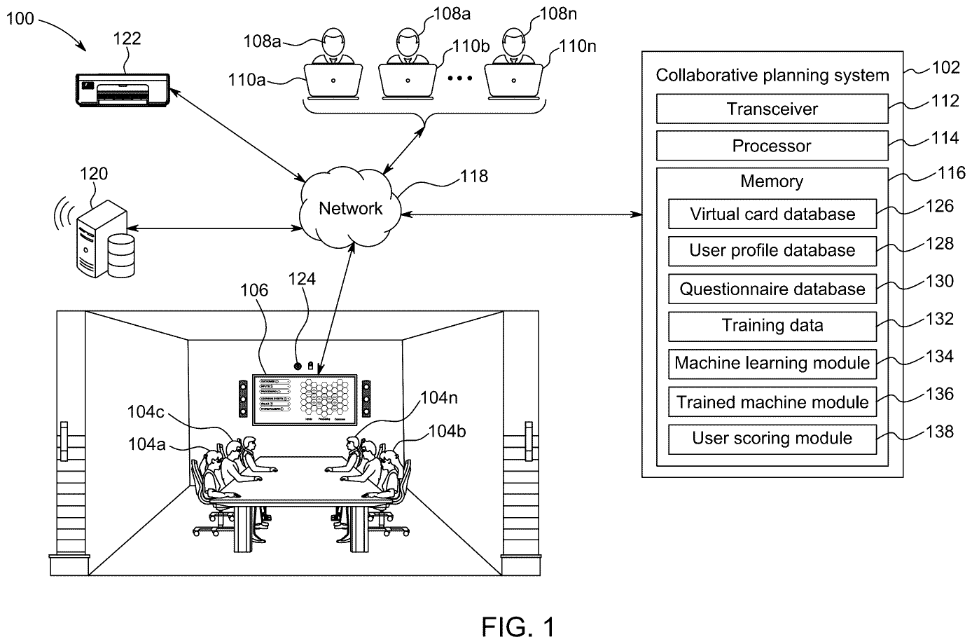

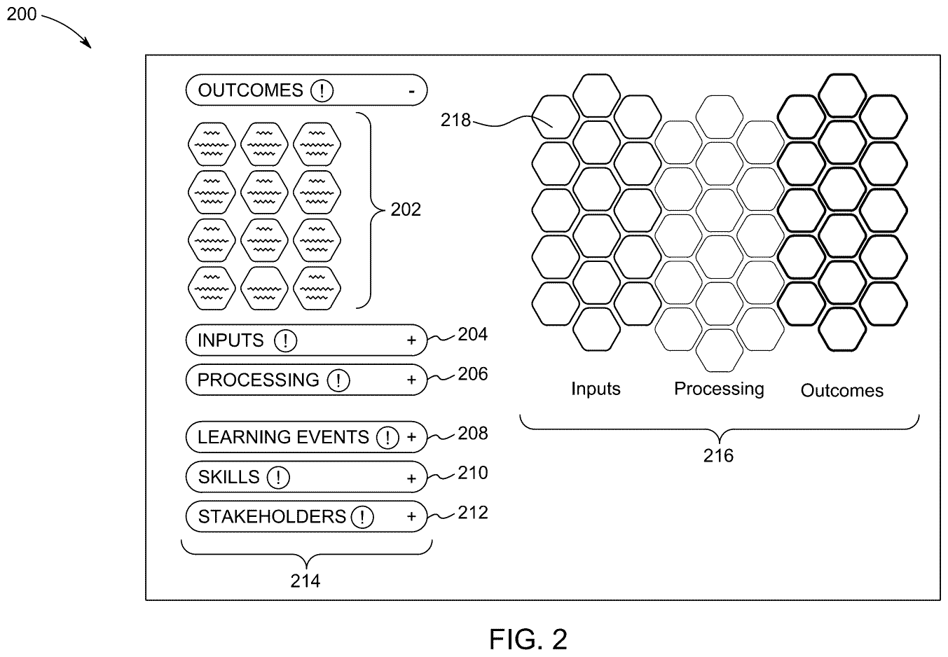

FIG. 1 depicts an example environment 100 in which techniques and structures for providing the systems and methods disclosed herein may be implemented. FIG. 1 will be described in conjunction with FIGS. 2, 3 and 4.

The environment 100 may include a collaborative planning system 102 (or system 102) that may be hosted on a server or a distributed computing system. The system 102 may be implemented in hardware, software (e.g., firmware), or a combination thereof. The system 102 may enable collaborative project planning in real-time amongst speakers/users of same language or different languages, and located in the same location physically or located at different locations. The system 102 enables a plurality of users to collaborate on real-life or imagined scenarios and creates an output that provides a roadmap for solving one or more particularly defined problems or achieving one or more particularly defined outcomes. In some aspects, the system 102 is a digital computer-assisted tool that provides a framework for stakeholders of different social or political backgrounds to be led through a gamified environment to solve a real-life or theoretical problem or issue, as described below in the present disclosure.

The environment 100 may further include a plurality of users 104a, 104b, 104c, 104n (collectively referred to as users 104) who may be located at a single or same geographical location (e.g., a conference room or a meeting room). The users 104 may be of same nationality or cultural background, or may be of different nationalities or cultural backgrounds. Further, the users 104 may speak the same language, or may speak different languages. In the exemplary aspect depicted in FIG. 1, the users 104 may be viewing/hearing visual and/or audio feed output from a user device 106 (which may be, for example, an Audio-Visual (AV) unit or a computing device) located at the conference/meeting room.

The environment 100 may further include a plurality of users 108a, 108b, 108n (collectively referred to as users 108) who may be located at different geographical locations. Similar to the users 104, the users 108 may be of same nationality or cultural background, or may be of different nationalities or cultural backgrounds. Further, the users 108 may speak the same language, or may speak different languages. In the exemplary aspect depicted in FIG. 1, each user 108a, 108b, 108n may be accessing respective user device 110a, 110b, 110n (collectively referred to as user device 110), which may be, for example, a computer, a laptop, a mobile phone, a tablet, or any other similar device with communication capabilities.

In some aspects, the users 104, 108 may be accessing the system 102 (specifically an application/“app” or a website associated with the system 102) via the respective user devices 106, 110. The system 102 may facilitate collaborative project planning amongst the users 104, 108, as described above. As an example, the users 104, 108 may be associated with governments, NGOs and/or militaries of different countries, and the system 102 may facilitate cross-border planning on real-life or imaginary scenarios dealing the countries. As another example, the users 104, 108 may be students of different colleges or universities who may be collaborating on a project. The system 102 facilitates collaborative project planning amongst the users 104, 108 by creating and displaying a gamified user interface that helps the users 104, 108 in building a visual roadmap or project plan for project execution. The details of the system 102 are described below.

The system 102 may include a plurality of components/units including, but not limited to, a transceiver 112, a processor 114 and a memory 116. The transceiver 112 may receive/transmit data, information, signals, etc. from/to one or more external systems and devices, via a network 118. The network 118 may be, for example, a communication infrastructure in which the connected devices discussed in various embodiments of this disclosure may communicate. The network 118 may be and/or include the Internet, a private network, public network or other configuration that operates using any one or more known communication protocols such as transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

Examples of the external systems and devices include, but are not limited to, the user devices 106, 110, one or more servers 120, one or more printers 122, a sensor unit 124, and/or the like. In an exemplary aspect, the transceiver 112 may receive audio and/or video feed from the user devices 110 (via the user devices'in-built cameras and microphones) when the users 108 may be accessing the system 102 via the user devices 110. Further, the transceiver 112 may transmit command signals, data, information, etc. to the user devices 106, 110, which may enable the user devices 106, 110 to render a user interface associated with the system 102 on the display screens associated with the user devices 106, 110.

The server 120 may provide real-time information associated with latest news and current affairs from across the world to the transceiver 112. Further, the printer 122 may print hardcopies of information/data that the transceiver 112 may transmit to the printer 122. In an exemplary aspect, the printer 122 may be located at the conference/meeting room where the users 104 may be present. Furthermore, the sensor unit 124 may also be located in the conference/meeting room where the users 104 may be present, and may include, for example, one or more cameras, microphones, and/or the like. The transceiver 112 may receive video and/or audio feed of the users 104 from the sensor unit 124.

The memory 116 may store programs in code and/or store data for performing various system operations in accordance with the present disclosure. Specifically, the processor 114 may be configured and/or programmed to execute computer-executable instructions stored in the memory 116 for performing various system functions in accordance with the disclosure. Consequently, the memory 116 may be used for storing code and/or data code and/or data for performing operations in accordance with the present disclosure.

In one or more aspects, the processor 114 may be in communication with one or more memory devices (e.g., the memory 116 and/or one or more external databases (not shown in FIG. 1)). The memory 116 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 116 may be one example of a non-transitory computer-readable medium and may be used to store programs in code and/or to store data for performing various operations in accordance with the present disclosure. The instructions in the memory 116 may include one or more separate programs, each of which may include an ordered listing of computer-executable instructions for implementing logical functions.

In some aspects, the memory 116 may include a plurality of modules and databases including, but not limited to, a virtual card database 126, a user profile database 128, a questionnaire database 130, a training data 132, a machine learning module 134, a trained machine module 136 and a user scoring module 138. The machine learning module 134, the trained machine module 136 and the user scoring module 138, as described herein, may be stored in the form of computer-executable instructions, and the processor 114 may be configured and/or programmed to execute the stored computer-executable instructions for performing system functions in accordance with the present disclosure. The functions associated with the memory modules and the training data 132 may be understood in conjunction with the description provided below.

In some aspects, the system 102 may be an Artificial Intelligence/Machine Learning (AI/ML) based system that may customize the system output based on real-time information associated with latest news and current affairs, user profiles associated with the users 104, 108, and/or the like. A person ordinarily skilled in the art may appreciate that machine learning is an application of Artificial Intelligence (AI) using which systems (e.g., the system 102) may have the ability to automatically learn and improve from experience without being explicitly programmed. Machine learning focuses on use of data and algorithms to imitate the way humans learn. In some aspects, the machine learning algorithms may be created to make classifications and/or predictions. Machine learning based systems may be used for a variety of applications including, but not limited to, speech recognition, physical movement recognition, content update, email filtering, medical diagnosis, and/or the like.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In the classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naïve Bayes, Decision Tree Classification, and Random Forest Classification.

In the regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression.

The unsupervised learning is an approach that involves algorithms that may be trained on unlabeled data. An unsupervised learning algorithm may analyze the data by its own and find patterns in input data. Further, semi-supervised learning is a combination of supervised learning and unsupervised learning. A semi-supervised learning algorithm involves labeled training data; however, the semi-supervised learning algorithm may still find patterns in the input data. Reinforcement learning is a multi-step or dynamic process. This model is similar to supervised learning but may not be trained using sample data. This model may learn “as it goes” by using trial and error. A sequence of successful outcomes may be reinforced to develop the best recommendation or policy for a given problem in reinforcement learning.

In an exemplary aspect, the system 102 may use a supervised machine learning module (e.g., the machine learning module 134) for effectively determining an optimal system visual output for the users 104, 108, which may facilitate the users 104, 108 in collaborative planning and building a roadmap for the scenario(s) that the users 104, 108 may be trying to solve or find a resolution for. Specifically, the system 102 may use supervised machine learning module to learn over time (based on explicit user feedback and/or by monitoring of the user interaction with the system 102 over time) the best visual output for the system user interface, which may make the user interaction with the system 102 more engaging and facilitate the users 104, 108 to collaborate more effectively. As an example, if a certain type of system user interface (or a certain type of virtual card depicted on the system user interface) makes the users 104, 108 disengaged (as determined by the supervised machine learning module based on the user feedback received over time), the system 102 may automatically update the system user interface (or the virtual card content) to make it more engaging for the users 104, 108.

The machine learning module 134 may be trained by using the training data 132 (as labeled data) to generate the trained machine module 136 (e.g., distributed models). Specifically, the machine learning module 134 may generate the trained machine module 136 to enable the system 102 to effectively determine an optimal system visual output for the users 104, 108. Since the machine learning module 134 is trained by using the training data 132 to generate the trained machine module 136, it may be appreciated/noted that the trained machine module 136 is trained by using the training data 132.

In one exemplary aspect, the training data 132 may include correlations between a plurality of virtual card content and information associated with news and current affairs. A virtual card (e.g., virtual cards 202 shown in FIG. 2) may be a visual piece of content or a digital card that the system 102 may cause the user interfaces of the user devices 106, 110 to display, based on command signals transmitted by the system 102. The details of the virtual cards are described later in the description below. In another exemplary aspect, the training data 132 may include correlations between a plurality of virtual card content and user profiles.

The system 102 may obtain the training data 132 from one or more external servers. The training data 132 may be regularly updated, e.g., based on continuous interactions of a plurality of users with the system 102 and/or based on continuous new information feed associated with latest news and current affairs that the system 102 may receive.

The machine learning module 134 may train the trained machine module 136 by using the training data 132. In some aspects, the machine learning module 134 may keep on updating or “re-training” the trained machine module 136 based on regular user feedback and/or new training data that the system 102 may obtain from the external servers and/or from multiple user interactions with the system 102. For example, the machine learning module 134 may re-train the trained machine module 136 based on the user feedback to make the system user interface more aligned with the preferences of the users 104, 108 or to make the system user interface more relevant for the users 104, 108.

In some aspects, the virtual card database 126 may store a data structure including a plurality of predefined virtual cards. Examples of virtual cards are shown in FIGS. 2, 3 and 4. Specifically, FIGS. 2, 3 and 4 depict a user device screen or a user interface 200 that may be associated with the user devices 106, 110. Based on command signals obtained from the system 102, the user interface 200 may display one or more virtual cards, as described later in the present disclosure.

In an exemplary aspect, the virtual card database 126 may store the predefined virtual cards in different categories, e.g., outcomes virtual cards 202, inputs virtual cards 204, processing virtual cards 206, learning events virtual cards 208, skills virtual cards 210, stakeholders virtual cards 212, and/or the like. Each virtual card may include or display a predefined text, which may be associated with that virtual card. As an example, the outcomes virtual cards 202 may include a plurality of virtual cards that may display content/text associated with expected or planned “outcomes” that the users 104, 108 may desire to achieve by collaborative planning. Specifically, the outcomes virtual cards 202 may include virtual cards that display higher-level objectives that the users 104, 108 may desire to achieve/accomplish. For example, if the users 104, 108 are associated with governments, NGOs, militaries, etc. of different countries, the outcomes virtual cards 202 may include virtual cards that display text/content such as “Strategy change or review” (e.g., plan to have the foreign government or military to change their strategy), “organization development”, “addressing game changers” (e.g., addressing a humanitarian crisis, a natural disaster, a foreign country coming in and buying the host country's assets, sudden change of leadership, etc.), “build capacity”, “build civil society sector” (e.g., NGOs, think tanks, etc.), “collaborative planning” (e.g., get the stakeholders together), and/or the like. Although FIGS. 2, 3 and 4 depict the virtual cards to be hexagonal-shaped, the present disclosure is not limited to such a design. The virtual cards may be of any other shape, e.g., octagonal, square, circular, etc., without departing from the present disclosure scope.

The inputs virtual cards 204 may include a plurality of virtual cards that may display types of knowledge and information that the users 104, 108 may require to build a plan to achieve the outcomes described above. For example, the inputs virtual cards 204 may include virtual cards that display text/content such as “policy research”, “partner gap assessment”, “neighboring nation coordination policy review”, and/or the like.

The processing virtual cards 206 may include a plurality of virtual cards that may display the steps that the users 104, 108 may need to perform on the knowledge and information received via the “inputs” described above, so that the users 104, 108 may action on them. For example, the processing virtual cards 206 may include virtual cards that may display text/content such as “report building”, “organization mapping”, “gender context”, “product design”, and/or the like.

The learning events virtual cards 208 may include a plurality of virtual cards that may display content/text associated with the events that the users 104, 108 may facilitate/execute in order to bring all the stakeholders together in achieving the outcomes described above. For example, the learning events virtual cards 208 may include virtual cards that may display text/content such as “learning fair”, “workshop”, “startup event”, and/or the like.

The skills virtual cards 210 may include a plurality of virtual cards that may display content/text associated with the skills that may be required by the users 104, 108/stakeholders to perform the steps in order to achieve the outcomes described above. For example, the skills virtual cards 210 may include virtual cards that may display text/content such as “Empathy”, “Active listening”, “Flexibility”, “Mindful”, “Social acumen”, “Self-awareness”, and/or the like. The text/content included in the skills virtual cards 210 may also be indicative of the training that may be required to be imparted to the users 104, 108/stakeholders.

The stakeholders virtual cards 212 may include a plurality of virtual cards that may display names of the stakeholders who may be required to achieve the outcomes. For example, the stakeholders virtual cards 212 may include virtual cards that display text/content such as “Civil Society Organizations”, “NGOs”, “Mentors”, “Private Sector”, “Consultants”, “Portfolio Experts”, and/or the like.

The examples of the virtual cards described above should not be construed as limiting. The virtual cards may be associated with different categories and/or may include different content/text, without departing from the present disclosure scope.

The user profile database 128 may store the user profiles associated with the users 104, 108 who may be accessing the system 102 via the user devices 106, 110. In an exemplary aspect, each user profile may include information associated with a user's name, age, nationality, languages known, cultural background, designation/rank, employer name, education qualification, gender, specific preferences or views on politics, countries, and/or the like.

The questionnaire database 130 may store predefined questionnaires or questions. The questionnaire may be associated with user personality assessment, skill assessment, preference or knowledge assessment, and/or the like.

In some aspects, the system 102 may implement one or more encryption methods (e.g., Blowfish, Twofish, RSA, etc.), data anonymization techniques, and comply with relevant local and/or global standards for secure data handling, to ensure that the information/data described above is secured. For example, by using one or more encryption techniques described above, the system 102 may ensure that the training data 132, the user profiles, the user feedback obtained over time, and/or the like, are securely stored in the memory 116.

In operation, when the users 104, 108 desire to engage in a collaborative planning exercise, the users 104, 108 may access the application or website associated with the system 102 on the user devices 106, 110. Responsive to the users 104, 108 accessing the system 102, the processor 114 may obtain real-time information associated with latest news and current affairs from the server 120. The processor 114 may further fetch the plurality of predefined virtual cards from the virtual card database 126. The processor 114 may then execute instructions stored in the trained machine module 136 to update content associated one or more virtual cards of the plurality of predefined virtual cards based on the information associated with latest news and current affairs. For example, the processor 114 may update content associated with one or more outcomes virtual cards 202, inputs virtual cards 204, processing virtual cards 206, and/or the like, based on the latest news and current affairs such that these cards reflect the latest happenings/events around the world. For instance, if the latest news indicate a presence of natural calamity, the processor 114 may update at least one outcomes virtual card 202 (or create a new outcome virtual card) to display “handling natural calamity” as one of the outcomes of the collaborative planning exercise. The processor 114 may similarly update one or more inputs virtual cards 204 and/or processing virtual cards 206 based on the news that indicate the presence of natural calamity.

In some aspects, in addition to updating the content associated with one or more virtual cards based on the latest news and current affairs, the processor 114 may update the content associated with one or more virtual cards based on the user profiles associated with the users 104, 108. In this case, the processor 114 may fetch the user profiles from the user profile database 128, and may correlate the user profiles with the latest news and current affairs. The processor 114 may then update the content associated with one or more virtual cards based on the correlation, such that the updated virtual cards are relevant to the users 104, 108. For example, if the users 104, 108 are college students, the processor 114 may not update the content based on the news indicating the presence of natural calamity (as “handling natural calamity” may not be relevant for college students). In this case, the processor 114 may identify any other latest news that may be relevant to college students and may accordingly update the virtual card content. On the other hand, if the users 104, 108 are government and/or military personnel, the processor 114 may update the content based on the news indicating the presence of natural calamity, as “handling natural calamity” may be relevant for such users as an outcome from the collaborative planning exercise.

Responsive to updating the content associated with one or more virtual cards from the plurality of predefined virtual cards as described above, the processor 114 may select a set of virtual cards (from all the virtual cards described above) that the system 102 may render on the user interface 200 (or the display screens associated with the user devices 106, 110). In some aspects, the processor 114 may select the set of virtual cards such that the selected virtual cards are relevant to the users 104, 108. In one exemplary aspect, the processor 114 may select the set of virtual cards (i.e., the “relevant” virtual cards), from all the virtual cards described above, based on the user profiles associated with the users 104, 108. In some aspects, the selected set of virtual cards includes the virtual cards whose content is updated by the processor 114 based on the user profiles and/or the latest news/current affairs, as described above.

Responsive to selecting the set of virtual cards, the processor 114 may render the selected set of virtual cards at a first location 214 of the user interface 200 (or the display screens associated with the user devices 106, 110), as shown in FIG. 2. In the exemplary aspect depicted in FIG. 1, the first location 214 is disposed towards a user interface left side, however, such depiction should not be construed as limiting. In some aspects, the set of virtual cards may be rendered as a “drop-down” menu under the different categories of the virtual cards described above.

In an exemplary aspect, the processor 114 may first “expand” the drop-down menu associated with the outcomes virtual cards 202 (as depicted in FIG. 2), so that the users 104, 108 may commence discussion on each outcomes virtual card 202 to select one or more outcomes virtual cards that may be relevant to the users 104, 108. As the users 104, 108 engage in the discussion on the outcomes virtual cards 202, the processor 114 may obtain video and/or audio feed associated with the users 104, 108 from the sensor unit 124 and the cameras and microphones associated with the user devices 110. The processor 114 may further determine that a consensus has been reached amongst the users 104, 108 in the communication session/discussion to select at least one outcomes virtual card from the outcomes virtual cards 202 (or the set of virtual cards) that may be rendered on the user interface 200, based on the inputs obtained from the sensor unit 124 and the cameras and microphones associated with the user devices 110. For example, the processor 114 may determine that a consensus has been reached amongst the users 104, 108 to select the virtual card displaying the content/text “handling natural calamity”, based on the inputs obtained from the sensor unit 124 and the cameras and microphones associated with the user devices 110.

In some aspects, the processor 114 may determine that a consensus has been reached amongst the users 104, 108 to select a virtual card from the set of virtual cards rendered on the first location 214 when the users 104, 108 engage in a conversation associated with the virtual card for more than a predefined time duration (e.g., for more than 1 or 2 minutes). In further aspects, the processor 114 may determine that a consensus has been reached amongst the users 104, 108 to select a virtual card from the set of virtual cards rendered on the first location 214 when the users 104, 108 use one or more predefined affirmative terms (e.g., “Yes”, “Agree”, etc.) or physical movements (e.g., an affirmative nod) for more than a predefined threshold count value while engaging in a conversation associated with the virtual card.

Responsive to determining that a consensus has been reached amongst the users 104, 108 to select a virtual card from the set of virtual cards rendered on the first location 214, the processor 114 may cause the virtual card to automatically move from the first location 214 to a second location 216 of the user interface 200. As depicted in FIG. 2, the second location 216 may include a plurality of receptacle cells 218 distributed in the same virtual card categories as described above. Each receptacle cell 218 may of same shape and/or size as the virtual cards located at the first location 214, and may receive a virtual card from the first location 214. In the exemplary aspect depicted in FIGS. 2, 3 and 4, the second location 216 is disposed at a user interface center portion, however, such depicted should not be construed as limiting.

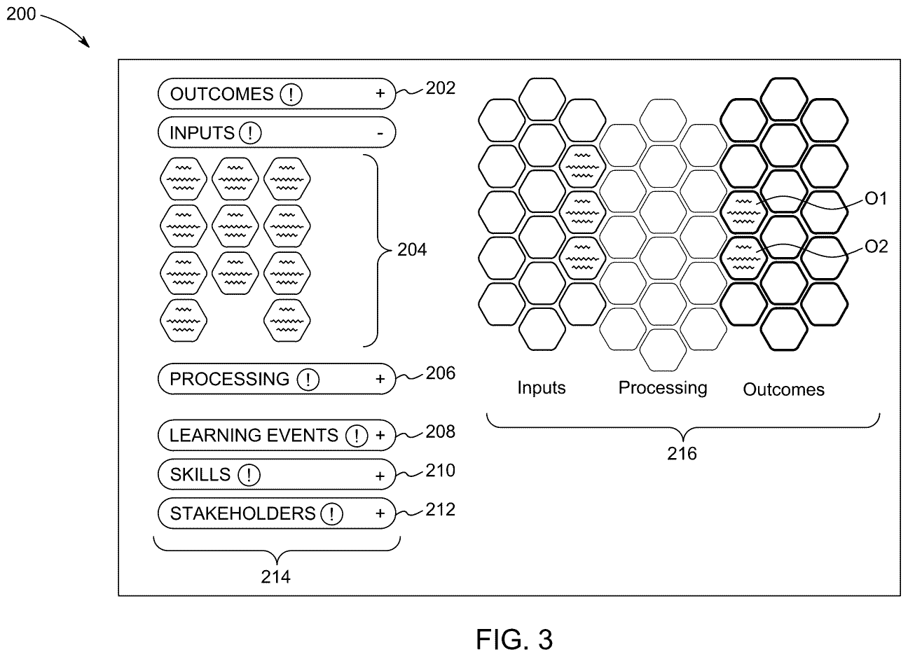

The processor 114 may cause the virtual card to automatically move from the first location 214 to the second location 216 such that the virtual card moves to a receptacle cell 218 of the same category as the category of the virtual card in the first location 214. For example, if the virtual card is moved from the outcomes virtual cards 202 category at the first location 214, the processor 114 may move the virtual card to the receptacle cell 218 of the “outcomes” category in the second location 216. An example view of two outcomes virtual cards “O1” and “O2” moved to the second location 216 is depicted in FIG. 3.

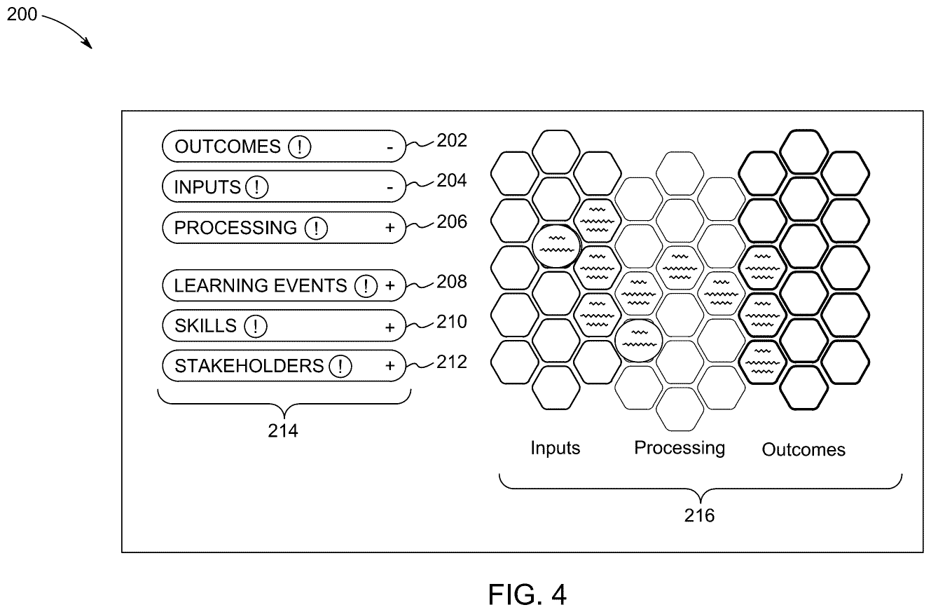

In some aspects, when the users 104, 108 reach to a consensus on selecting the outcomes virtual cards “O1” and “O2”, the user 104, 108 may engage in conversation on selecting other virtual cards from the remaining categories, e.g., “inputs”, “processing”, “learning events”, etc. The processor 114 may similarly determine that a consensus has been reached for one or more additional virtual cards from the remaining categories based on the inputs obtained from the sensor unit 124 and camera/microphones, and automatically move the additional virtual cards from their respective positions in the first location 214 to the second location 216, as described above. An example view of different virtual cards (e.g., inputs, processing and outcomes virtual cards) being moved to the second location 216 is depicted in FIG. 4. In some aspects, the processor 114 may not move any additional card to the second location 216 till at least one outcomes virtual card is moved to the second location 216. Stated another way, the processor 114 may not move any additional card to the second location 216 till the users 104, 108 reach to a consensus on at least one outcomes virtual card.

Responsive to moving the different “selected” virtual cards to the second location 216 as depicted in FIG. 4 and responsive to determining that the communication session amongst the users 104, 108 is over (based on the inputs obtained from the sensor unit 124 and camera/microphones or when the allocated time for the communication session is over), the processor 114 may capture a snapshot of the second location 216 including the virtual cards. For example, the processor 114 may capture a second location snapshot depicted in the user interface 200 of FIG. 4. Responsive to capturing the second location snapshot, the processor 114 may transmit a command signal to the printer 122 to print one or more copies of the snapshot. The printed copies may be distributed amongst the users 104 who may be located at the conference/meeting room. The processor 114 may additionally transmit the second location snapshot to the user devices 110 so that the users 108 may also take the print out of the second location snapshot.

In some aspects, the second location snapshot may act as a roadmap for the users 104, 108 to collaboratively achieve the outcomes selected by the entire user group by reaching consensus on each virtual card (and hence each “step” or action item mentioned in the virtual cards moved to the second location 216). Each user 104, 108 may keep the second location snapshot, which may act as a guiding principle for the users 104, 108. In this manner, the system 102 facilities the users 104, 108 in collaborative planning, and building a roadmap to solve any challenge or resolve any issue by reaching to a consensus on each virtual card. It may be appreciated from the description above that the output from the system 102 is in the form of a “map” or a “flow diagram”, which lists the inputs, processing steps, and the outcomes that the user 104, 108 desire to collectively achieve and implement.

The system 102 may implement additional steps or provide additional features that may enhance user's experience of accessing and operating the system 102. For example, before the users 104, 108 access the system 102 or responsive to the users 104, 108 accessing the system 102 via the user devices 106, 110, the system 102/processor 114 may fetch a questionnaire from the questionnaire database 130 and transmit the fetched questionnaire to the users 104, 108 via the user devices 106, 110 (or personal user devices associated with the users 104, 108). The processor 114 may then obtain responses from one or more users (via their respective user devices) on the questionnaire.

In some aspects, in addition or alternative to selecting the set of virtual cards to be rendered on the first location 214 based on the latest news and/or the user profiles as described above, the processor 114 may select the set of virtual cards based on the obtained responses on the questionnaire. In a similar manner, in addition or alternative to updating content associated with one or more virtual cards based on the latest news and/or the user profiles as described above, the processor 114 may update the virtual card content based on the obtained responses on the questionnaire.

In further aspects, the memory 116 may store information associated with historical selection of virtual cards by one or more users from the users 104, 108 (e.g., when the users may have accessed the system 102 in the past), and the processor 114 may update the content associated with one or more virtual cards and/or select the set of virtual cards to be rendered on the first location 214 based on the information associated with historical selection of virtual cards by one or more users.

The processor 114 may additionally update the virtual card content and/or select the relevant virtual cards for display based on user feedback received by the system 102 over time. The system 102 may implement one or more different ways of incorporating user feedback to improve the system performance over time (e.g., update the virtual card content, the system's usability, user interface, etc.). For instance, in one exemplary aspect, the system 102 may seek explicit feedback from the users 104, 108 by transmitting a user feedback form/survey at the end of the user interaction session with the system 102, and then update the virtual card content over time based on the received feedback. In another exemplary aspect, the system 102 may track users'interaction amongst themselves and/or users'movement and/or facial expressions while engaging in the interaction session with the system 102 (e.g., via the feed obtained from the sensor unit 124), and may update the virtual card content over time based on the monitored users'interaction/movement. For example, the system 102 may update the virtual card content if the users 104, 108 seem disinterested in a particular type of virtual card, as determined via the feed obtained from the sensor unit 124.

In additional aspects, the processor 114 may execute instructions stored in the user scoring module 138 to “score” each user or assign a score to each user, from the users 104, 108, based on the inputs obtained from the sensor unit 124 and the cameras/microphones associated with the user devices 110. In some aspects, the processor 114 may assign a score to each user based on an average time duration the user has taken to reach to the consensus for the virtual cards that the processor 114 moves to the second location 216. Stated another way, the processor 114 may assign a score to each user based on how quickly the user reaches to a consensus for each virtual card during the communication session involving the users 104, 108. In other aspects, the processor 114 may assign a score to each user based on the types of virtual cards selected by the users 104, 108 for movement to the second location 216, whether the users 104, 108 are unsure or indecisive about the virtual cards to move to the second location 216, different soft skill aspects by observing the user's interaction with other users in the communication session, how the user has responded to the questionnaire, and/or the like. Responsive to assigning the score to each user, the processor 114 may transmit the score to the respective user devices 106, 110. The processor 114 may further determine or recommend training needs for each user based on the assigned score.

In some aspects, the processor 114 may also select one or more skill virtual cards, from the skills virtual cards 210, based on the user profiles and the outcome virtual cards decided/selected by the users 104, 108. The processor 114 may also use known correlations (e.g., from historical data) of skill sets required by different types of users to achieve different outcomes, to select one or more skills virtual cards for the users 104, 108.

In some aspects, the processor 114 may additionally refine its scoring algorithms based on the user feedback obtained over time. For example, if the user feedback indicates that the system 102 is overly lenient in user scoring (determined based on the user feedback), the processor 114 may automatically refine its scoring algorithms to correctly score the users. In addition to scoring the users 104, 108, the processor 114 may additionally offer/provide virtual gifts, badges, rewards, etc. to the users 104, 108, to make the user interaction with the system 102 more engaging. The processor 114 may also provide/display user-specific analytics to enable the users 104, 108 to check their (individual or group's) performance over time. Such analytics may encourage collaboration and healthy engagement amongst the users 104, 108.

Furthermore, the system 102 may translate languages in real-time so that users can use the system 102 in their native language and collaborate in real-time irrespective of the languages used.

In additional aspects, the system 102 may enable the users 104, 108 or a human facilitator to set a total time (e.g., in hours) that the users 104, 108 may spend on achieving the outcomes, and each virtual card may be associated with a certain time/hour value (which may be indicative of the time required to perform the step displayed on the virtual card). The users 104, 108 may select the virtual cards to move to the second location 216 such that the cumulative hour value of the selected virtual cards is less than or equivalent to the total time set by the human facilitator.

In further aspects, the system 102 may be tested (e.g., user tested) or validated before it is rolled out to the users and/or when new system features are being implemented. The system 102 may be tested on a small user base (that may be located locally, or may be located in different countries), and the user feedback may be incorporated into the system features before the system 102 is rolled out to a large group of users for interaction and collaboration.

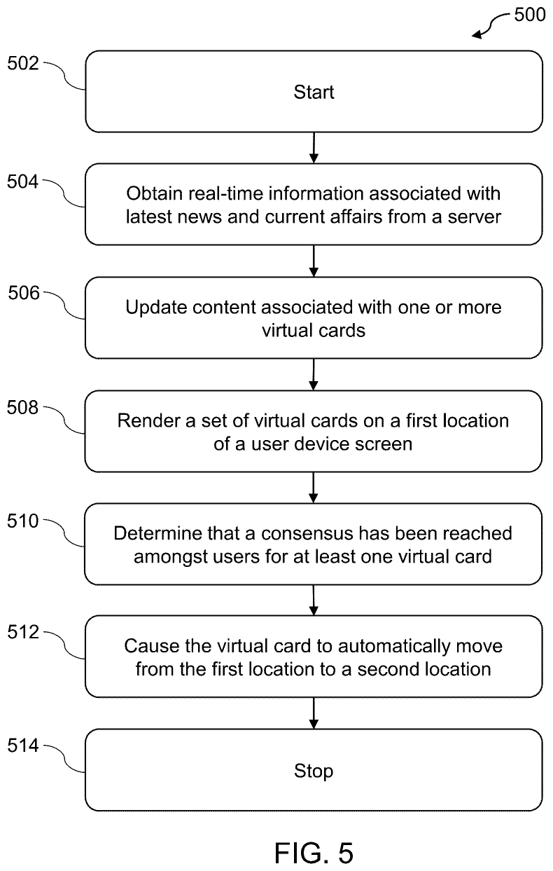

FIG. 5 depicts a flow diagram of an example method 500 for facilitating collaborative planning in accordance with the present disclosure. FIG. 5 may be described with continued reference to prior figures, including FIGS. 1-4. The following process is exemplary and not confined to the steps described hereafter. Moreover, alternative embodiments may include more or less steps than are shown or described herein and may include these steps in a different order than the order described in the following example embodiments.

Referring to FIG. 5, at step 502, the method 500 may commence. At step 504, the method 500 may include obtaining, by the processor 114, real-time information associated with latest news and current affairs from the server 120. At step 506, the method 500 may include executing, by the processor 114, instructions stored in the trained machine module 136 to update content associated with one or more virtual cards based on the real-time information.

At step 508, the method 500 may include rendering, by the processor 114, the set of virtual cards at the first location 214. At step 510, the method 500 may include determining, by the processor 114, that a consensus has been reached amongst the users 104, 108 engaged in a communication session to select at least one virtual card from the set of virtual cards based on inputs obtained from the sensor unit 124 and cameras/microphones associated with the user devices 110. At step 512, the method 500 may include causing, by the processor 114, the virtual card to automatically move from the first location 214 to the second location 216, responsive to determining that the consensus has been reached.

At step 514, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a memory configured to store a data structure comprising a plurality of predefined virtual cards, a training data and a trained machine module, wherein:
the trained machine module is trained using the training data, and
the training data comprises a correlation between a plurality of virtual card content and information associated with news and current affairs; and
a processor configured to:
obtain a real-time information associated with latest news and current affairs from a server;
execute instructions stored in the trained machine module to update content associated with one or more virtual cards of the plurality of predefined virtual cards based on the real-time information;
render a set of virtual cards, from the plurality of predefined virtual cards, at a first location of a user device screen, wherein the set of virtual cards comprises the one or more virtual cards;
determine that a consensus has been reached amongst a plurality of users engaged in a communication session to select at least one virtual card from the set of virtual cards based on inputs obtained from a sensor unit, wherein the sensor unit is configured to capture video and audio associated with the plurality of users; and
cause the at least one virtual card to automatically move from the first location to a second location of the user device screen, responsive to determining that the consensus has been reached.

2. The system of claim 1, wherein the plurality of users is located at a single geographical location, and wherein the sensor unit comprises one or more cameras and one or more microphones located at the single geographical location.

3. The system of claim 1, wherein the plurality of users is located at different geographical locations, and wherein the sensor unit comprises one or more cameras and one or more microphones located in proximity to each user of the plurality of users.

4. The system of claim 1, wherein the processor determines that the consensus has been reached for the at least one virtual card when the plurality of users engage in a conversation associated with the least one virtual card for more than a predefined time duration.

5. The system of claim 1, wherein the processor determines that the consensus has been reached for the at least one virtual card when the plurality of users use one or more predefined affirmative terms or physical movements for more than a predefined threshold count value while engaging in a conversation associated with the least one virtual card.

6. The system of claim 1, wherein the processor is further configured to:
capture a snapshot of the second location comprising the at least one virtual card, responsive to causing the at least one virtual card to automatically move from the first location to the second location; and
transmit a command signal to a printer to print a copy of the snapshot.

7. The system of claim 1, wherein the processor is further configured to:
capture a snapshot of the second location comprising the at least one virtual card, responsive to causing the at least one virtual card to automatically move from the first location to the second location; and
transmit the snapshot to a plurality of user devices associated with the plurality of users.

8. The system of claim 1, wherein the memory is further configured to store user profiles associated with the plurality of users.

9. The system of claim 8, wherein the processor is further configured to:
select the set of virtual cards based on the user profiles; and
render the set of virtual cards at the first location responsive to selecting the set of virtual cards.

10. The system of claim 8, wherein the processor is further configured to update content associated with the one or more virtual cards based on the user profiles.

11. The system of claim 1, wherein the processor is further configured to:
transmit a questionnaire to a plurality of user devices associated with the plurality of users;
obtain responses from one or more user devices, of the plurality of user devices, responsive to transmitting the questionnaire; and
update content associated with the one or more virtual cards based on the responses.

12. The system of claim 1, wherein the memory is further configured to store an information associated with historical selection of virtual cards by one or more users of the plurality of users.

13. The system of claim 12, wherein the processor is further configured to update content associated the one or more virtual cards based on the information associated with historical selection.

14. The system of claim 12, wherein the processor is further configured to select the set of virtual cards based on the information associated with historical selection.

15. The system of claim 1, wherein the processor is further configured to:
assign a score to each user of the plurality of users based on the inputs obtained from the sensor unit; and
transmit the score to respective user device of each user.

16. The system of claim 15, wherein the processor assigns the score to each user based on a time duration each user takes to reach to the consensus.

17. A method comprising:
obtaining, by a processor, a real-time information associated with latest news and current affairs from a server;
executing, by the processor, instructions stored in a trained machine module to update content associated with one or more virtual cards of a plurality of predefined virtual cards based on the real-time information, wherein:
the trained machine module is trained using a training data, and
the training data comprises a correlation between a plurality of virtual card content and information associated with news and current affairs;
rendering, by the processor, a set of virtual cards, from the plurality of predefined virtual cards, at a first location of a user device screen, wherein the set of virtual cards comprises the one or more virtual cards;
determining, by the processor, that a consensus has been reached amongst a plurality of users engaged in a communication session to select at least one virtual card from the set of virtual cards based on inputs obtained from a sensor unit, wherein the sensor unit is configured to capture video and audio associated with the plurality of users; and
causing, by the processor, the at least one virtual card to automatically move from the first location to a second location of the user device screen, responsive to determining that the consensus has been reached.

18. The method of claim 17 further comprising:
capturing a snapshot of the second location comprising the at least one virtual card, responsive to causing the at least one virtual card to automatically move from the first location to the second location; and
transmitting a command signal to a printer to print a copy of the snapshot.

19. The method of claim 17 further comprising:
capturing a snapshot of the second location comprising the at least one virtual card, responsive to causing the at least one virtual card to automatically move from the first location to the second location; and
transmitting the snapshot to a plurality of user devices associated with the plurality of users.

20. A non-transitory computer-readable storage medium in a distributed computing system, the non-transitory computer-readable storage medium having instructions stored thereupon which, when executed by a processor, cause the processor to:
obtain a real-time information associated with latest news and current affairs from a server;
execute instructions stored in a trained machine module to update content associated with one or more virtual cards of a plurality of predefined virtual cards based on the real-time information, wherein:
the trained machine module is trained using a training data, and
the training data comprises a correlation between a plurality of virtual card content and information associated with news and current affairs;
render a set of virtual cards, from the plurality of predefined virtual cards, at a first location of a user device screen, wherein the set of virtual cards comprises the one or more virtual cards;
determine that a consensus has been reached amongst a plurality of users engaged in a communication session to select at least one virtual card from the set of virtual cards based on inputs obtained from a sensor unit, wherein the sensor unit is configured to capture video and audio associated with the plurality of users; and
cause the at least one virtual card to automatically move from the first location to a second location of the user device screen, responsive to determining that the consensus has been reached.
